(19) United States
(12) Patent Application Publication
(10) Pub. No.: US 2026/0093451 A1
(43) Pub. Date: Apr. 2, 2026

(54) FASTER AND ACCURATE FORWARD GEOHASHING FOR GEOSPATIAL DATA

(71) Applicant: Databricks, Inc., San Francisco, CA (US)

(72) Inventors: Menelaos Karavelas, San Ramon, CA (US); Nemanja Boric, Berlin (DE)

(21) Appl. No.: 18/925,393

(22) Filed: Oct. 24, 2024

(30) Foreign Application Priority Data
Sep. 27, 2024 (GR) 20240100662

(51) Int. Cl. G06F 5/01; G06F 7/487

(52) U.S. Cl. CPC G06F 5/012; G06F 7/487

(57) ABSTRACT

A data processing service executes a new forward and reverse geohashing process that is correct up to a threshold geohash precision. The forward and reverse geohashing processes described are correct for precisions up to 18, where a precision corresponds to 5 geohash bits. The forward geohashing process gives correct results for precisions up to 19, and the reverse geohashing process gives correct results for precisions up to 20. The geohashing methods described herein is configured to perform a relatively small number of floating point and integer operations to avoid the iterative nature of existing geohashing processes. Moreover, the transformations are completed in an accurate way while saving more computational power compared to existing geohash algorithms.

### CROSS-REFERENCE TO RELATED APPLICATIONS

This application claims the benefit of Greece Patent Application Serial No. 20240100662, filed on Sep. 27, 2024, which is incorporated herein by reference in its entirety.

### TECHNICAL FIELD

The disclosed configuration relates generally to geohashing, and more particularly to encoding and/or decoding using an improved geohashing process for geospatial data.

### BACKGROUND

Geohashing is a geocoding system that subdivides the longitude and latitude range of geographic coordinates of locations into a multi-resolution grid. The grid buckets are represented using an encoding (e.g., 32-base encoding). Geohashing offers appealing properties. For example, two geohashes of the same resolution that have a common prefix correspond to points that are spatially close to each other. As another example, the common prefix of two geohashes corresponds to a geohash grid bucket that contains both points. As another example, a geohash grid bucket at a resolution geometrically includes grid buckets at a higher resolution with the same prefix. The geohashing process for computing the geohash value of a point at a certain resolution subdivides the longitude and latitude range iteratively. At each subdivision step, the process returns bits indicating whether the point is above or below the midpoint of the subdivision if dividing latitudes, or alternatively whether the point is left or right of the midpoint of the subdivision if dividing longitudes. The bits for longitudes are interleaved with the bits for latitudes, and the interleaved bits represent the result of geohashing.

### BRIEF DESCRIPTION OF THE DRAWINGS

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an architecture of a cluster computing system of the data layer, in accordance with an embodiment.

FIG. 5 illustrates a method for performing geohashing to encode a geospatial location, in accordance with an embodiment.

FIG. 6 illustrates a method for performing a reverse geohash operation to a geohash string, in accordance with an embodiment.

FIG. 7 is a block diagram illustrating an example machine to read and execute computer readable instructions, in accordance with an embodiment.

The figures depict various embodiments of the present configuration for purposes of illustration only. One skilled in the art will readily recognize from the following discussion that alternative embodiments of the structures and methods illustrated herein may be employed without departing from the principles of the configuration described herein.

### DETAILED DESCRIPTION

### Overview

Geohashing is a geocoding system that subdivides the longitude and latitude range of geographic coordinates of locations into a multi-resolution grid. Current methods of performing geohashing require many operations and are often iterative, further increasing processing time. A data processing service executes a new forward and reverse geohashing process that is correct up to a threshold geohash precision. In one embodiment, the forward and reverse geohashing processes described herein are correct for precisions up to 18, where a precision corresponds to 5 geohash bits. In one embodiment, the forward geohashing process gives correct results for precisions up to 19, and the reverse geohashing process gives correct results for precisions up to 20. The geocaching methods described herein is configured to perform a relatively small number of floating point and integer operations to avoid the iterative nature of existing geohashing processes. Moreover, the transformations are completed in an accurate way while saving more computational power compared to existing geohash algorithms.

### Data Processing Service System Environment

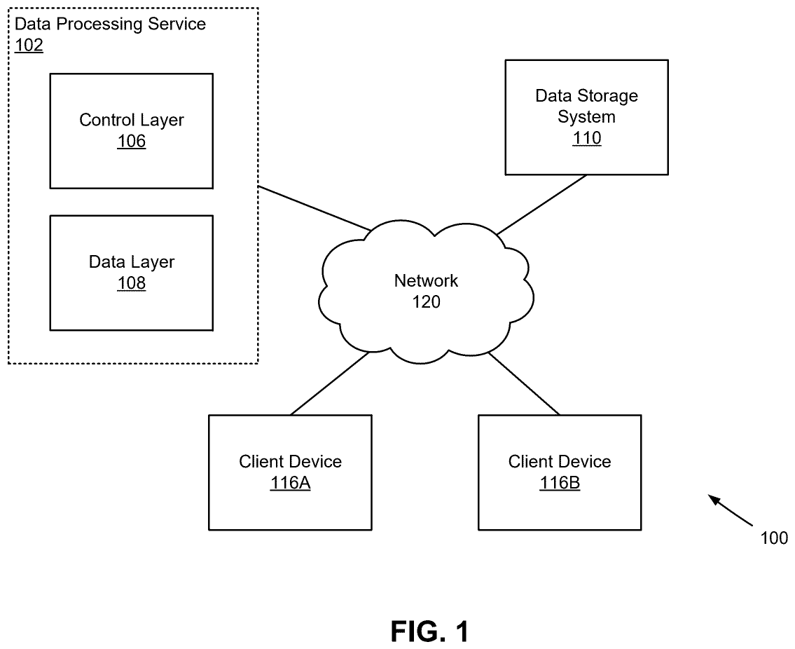

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 are to be activated to process the request with certain memory requirements. Responsive to receiving this information, the control layer 106 may send instructions to the data layer 108 to activate the requested number of clusters and configure the clusters according to the requested memory requirements.

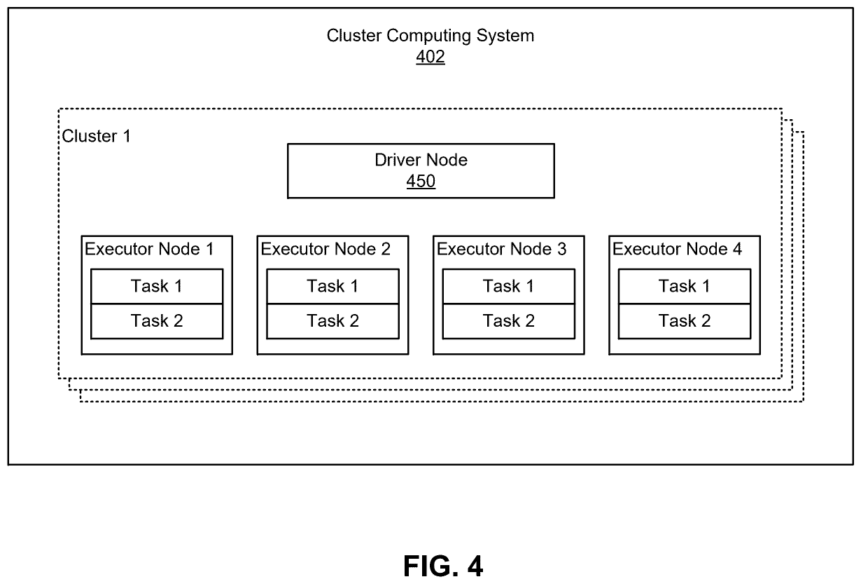

The data layer 108 includes multiple instances of clusters of computing resources that execute one or more jobs received from the control layer 106. Accordingly, the data layer 108 may include a cluster computing system for executing the jobs. An example of a cluster computing system 402 is described in relation to FIG. 4. In one instance, the clusters of computing resources are virtual machines or virtual data centers configured on a cloud infrastructure platform. In one instance, the data layer 108 is configured such that a plurality of data layer instances process data pertaining to various tenants of the data processing service 102, where a data layer of a respective tenant may reside within its own virtual private cloud (VPC) network. Each tenant's data is isolated and remains invisible to other tenants. For example, a respective data layer instance can be implemented for a respective tenant.

Data layer 108 thus may be accessed by, for example, a developer through an application of control layer 106 to execute code developed by the developer. In one embodiment, a cluster in data layer 108 may include multiple worker nodes that execute multiple jobs in parallel. Responsive to receiving a request, data layer 108 divides the cluster computing job into a set of worker jobs, provides each of the worker jobs to a worker node, receives worker job results, stores job results, and the like. Data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, components of the control layer 106 receive a request from a user to apply a geohash to a batch of data, for example to encode a pair of longitude and latitude coordinates into a geohash representation or conversely, decode a geohash representation into respective pair of longitude and latitude coordinates. Depending on the resolution of the geohash, the encoding may cover a larger (e.g., when resolution is low) or smaller (e.g., when resolution is high) region on a projection of the globe (e.g., 2-D projection of the globe) or region of the degree-based parameterization of the globe in longitude-latitude space. The components of the data processing service 102 described herein perform a new geohashing process that performs a smaller number of floating point and integer operations compared to existing geohashing processes. Moreover, some existing non-iterative geohashing algorithms may introduce a degree of error in the geohash representation. However, the methods and systems described herein generates an exact geohash representation with a fewer number of operations.

Data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data management system 110 may be managed by the same entity that manages the data processing service 102. In one embodiment, the data storage system 110 includes an authentication service that verifies whether an access request from a cluster computing resource to access one or more data assets (e.g., data tables, metadata) is appropriate based on the trust and permission policies associated with the account associated with the request.

Client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client device 116 is a conventional computer system, such as a desktop or laptop computer. Alternatively, client device 116 may be a device having computer functionality, such as a personal digital assistant (PDA), a mobile telephone, a smartphone or another suitable device. A client device 116 is configured to communicate via network 120, which may comprise any combination of local area and/or wide area networks, using both wired and/or wireless communication systems.

In one embodiment, a client device 116 executes an application allowing a user of the client device 116 to interact with the various systems of the system environment 100 of FIG. 1. For example, a client device 116 can execute a browser application to enable interaction between the client device 116 and the data processing system 106 via the network 120. In another embodiment, the client device 116 interacts with the various systems of the system environment 100 through an application programming interface (API) running on a native operating system of the client device 116, such as IOS® or ANDROID™.

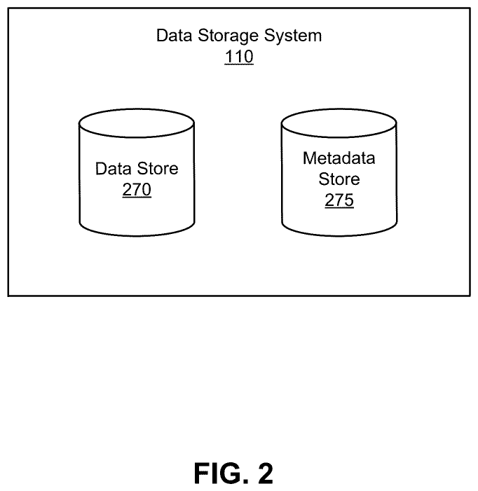

FIG. 2 is a block diagram of an architecture of a data storage system 108, in accordance with an embodiment. In one embodiment, the data storage system 108 includes a data ingestion module 250. The data storage system 108 also includes a data tables store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, users of the data processing service 102 may store data tables including a plurality of geospatial data instances. As an example, a data table may store one or more data instances as a plurality of rows, where each instance stores data including at least a particular geospatial cell index, a resolution of the cell index, and the like. As described in further detail below, the geospatial cell indices may be represented as 64-bit integers, unique to each cell encoding a particular region on the map at a particular resolution. The users of the data processing service 102 may request jobs, such as queries, on the geospatial data.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that includes another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity and may indicate the specific changes to individual records with an indication of whether the record was inserted, deleted, or updated due to the corresponding transaction.

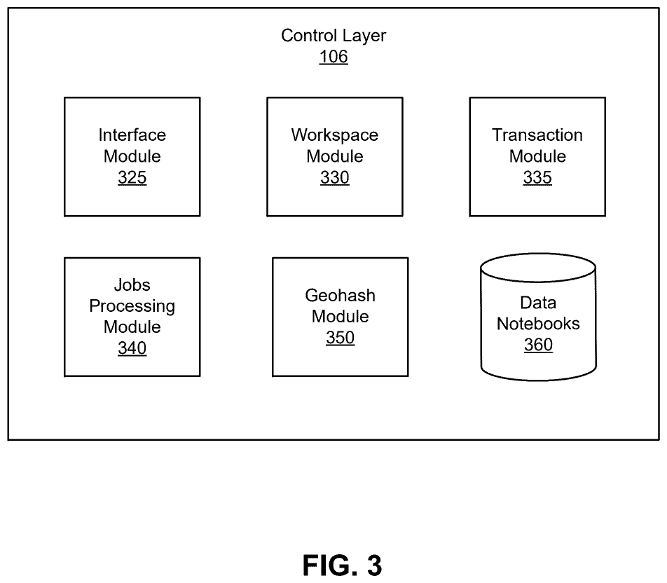

FIG. 3 is a block diagram of an architecture of control layer 106, in accordance with an embodiment. In one embodiment, data processing system 106 includes an interface module 325, a workspace module 330, a transaction module 335, a jobs processing module 340, and/or a geohash module 350. The control layer 106 also includes a data notebook store 360.

The interface module 325 provides an interface and/or a workspace environment where users of client devices 116 (e.g., users associated with tenants) can access resources of data processing service 102. For example, the user may retrieve information from data tables associated with a tenant, submit data processing requests such as query requests on the data tables, through the interface provided by interface module 325. The interface provided by interface module 325 may include notebooks, libraries, experiments, queries submitted by the user. In one embodiment, a user may access the workspace via a user interface (UI), a command line interface (CLI), or through an application programming interface (API) provided by workspace module 330.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The workspace module 330 deploys workspaces within data processing service 102. A workspace as defined herein may refer to a deployment in the cloud that functions as an environment for users of the workspace to access assets. An account of data processing service 102 represents a single entity that can include multiple workspaces. In one embodiment, an account associated with data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 335 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The jobs processing module 340 receives and processes queries that access data stored in the data storage system 110. In one embodiment, the jobs may include queries on data, workflows, extract, transform, and load (ETL) jobs, and the like. The queries processed by jobs processing module 340 are referred to herein as queries. The queries are specified using a declarative language such as SQL. The jobs processing module 340 may encounter runtime errors during execution of a query and returns information describing the runtime errors including an origin of the runtime error representing a position of the runtime error in the query. In one embodiment, the jobs processing module 340 provides one or more queries to appropriate compute resources of the data layer 108 and receives responses to the queries from clusters in which the queries are executed.

The jobs processing module 340 receives, from users, requests to perform one or more data processing operations. In one embodiment, the jobs processing module 340 receives a request to apply one or more geohash-related processes. In one instance, the geohash-related processes may include a forward geohash which is to encode a geographical location in a given format (e.g., longitudinal and latitudinal coordinates) to a geohash representation, and/or a reverse geohash which is to decode a geohash representation to a geographical location in the given format.

The geohash module 350 maintains code for certain geohashing functions including forward and reverse geohashes. The geohash module 350 compiles the code into compiled code. As described above, the values of the geohashing functions described herein are equivalent to existing geohashing functions for a geohash value of up to 18 characters, where 1 character corresponds to 5 geohash bits. In one instance, the geohash module 350 provides the compiled code for geohashing operations as a binary library to compute resources of the cluster computing system 402. A detailed description of the code for geohashing processes is described below.

FIG. 4 is a block diagram of an architecture of a cluster computing system 402 of the data layer 108, in accordance with an embodiment. In one embodiment, the cluster computing system 402 includes driver node 450 and worker pool including multiple executor nodes. The driver node 450 receives one or more jobs for execution, divides a job into job stages, and provides job stages to executor nodes, receives job stage results from the executor nodes of the worker pool, and assembles job stage results into complete job results.

In one embodiment, the driver node receives a request to execute one or more queries from the jobs processing module 340. The driver node 450 may compile a database query and generate an execution plan. The driver node 450 may then perform a code generation phase to generate executable code based on the execution plan. The driver node 450 distributes the query information including the generated code to the executor nodes, such that the executor nodes execute the query based on the received information. In one embodiment, the driver node 450 compiles the database query into one or more executable tasks and distributes the executable tasks to one or more executor nodes (also referred to herein as “worker nodes”). An executable task may execute the generated code from the code generation phase.

In an example embodiment, the driver node 450 receives a query with data processing operations including one or more geohashing functions. The driver node 450 determines that a portion of the execution plan corresponding to the geospatial function operation has an implementation that was compiled from code. In this case, an engine in the driver node 450 modifies the execution plan to use the implementation. The driver node 450 executes the code by calling the native implementation for that portion of the query. The tasks are distributed to the executor nodes.

The worker pool can include any appropriate number of executor nodes (e.g., 4, 12, 128, 256 executor nodes). An executor node in the worker pool includes one or more execution engines (not shown in FIG. 4) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the generated code for the database query for a particular subset of data that is processed by the database query. The executor nodes execute the query based on the received information from the driver node 450.

### Fast and Exact Geohashing Processes

As described above, the geohash module 350 maintains and stores computer program code for one or more geohashing operations. The geohash module 350 stores code (e.g., written by a developer) for the geohashing operations, and compiles the code to generate compiled code. Thus, when a user query is submitted to the driver node 450, the driver node 450 can call the appropriate implementations during the query compile process, such that these operations can be run faster and with higher computational efficiency. In one embodiment, the disclosure herein describes three processes for geohashing, forward geohashing, reverse geohashing, and geohash grid bucket computing.

In one embodiment, the floating point operations and integer operations described herein may be performed in computer memory on one or more registers. For example, the cluster computing system 402 includes a set of floating point registers for performing floating point arithmetic operations and a set of integer registers for performing integer arithmetic operations.

### 1. Forward Geohashing

A forward geohashing process generates a geohash representation from a pair of longitude and latitude coordinate values. In one embodiment, components of the cluster computing system 402 of FIG. 4 (e.g., one or more executor nodes) are configured to perform the steps described herein. The geohash module 305 stores code that performs fast forward geohashing. For the sake of explanation, a primary example where x=47 and y=72 and a geohashing process for precision 16 is described herein, where x and y both denote degrees. However, it is appreciated that any other appropriate values can be used in conjunction with the disclosure provided herein.

One step (step “1(a)”) of forward geohashing is to divide the value with 180 for the latitude coordinate and 90 for the longitude coordinate. In one embodiment, this step is performed as a floating point operation (e.g., using one or more 64-bit floating point registers in memory) with doubles to map the input values to the [−1, 1] interval. In the primary example,

$$X = 47 / 180 = 0.261111111111111 , Y = 72 / 90 = 0.8 ,$$

and the double floating point for these scaled values are:

$$0011111111010000101101100000101101100000101101100000101101100001$$

$$( X = x / 180 )$$

$$0011111111101001100110011001100110011001100110011001100110011010$$

$$( Y = y / 90 )$$

where the first bit is the sign bit.

The next step (step “1(b)”) is to multiply the scaled values with 2⁶², where 2⁶² is represented as a double floating point number. This is also a floating point operation, and results in modifying the exponent but not the mantissa of the result of 1(a). This step maps the values from the [−1, 1] interval to the [−2⁶², 2⁶²] interval. In the primary example, the multiplied values are:

$$01000001111010000000000000000000000000000000000000000000000000000$$

$$( {2}^{∧} 62 )$$

$$0100001110110000101101100000101101100000101101100000101101100001$$

$$( X ⋆ {2}^{∧} 62 )$$

$$0100001111001001100110011001100110011001100110011001100110011010$$

$$( Y ⋆ {2}^{∧} 62 )$$

where the first bit is the sign bit.

The next step (step “1(c)”) is to cast the result of 1(b) as a signed 64-bit integer. This step preserves the bits in the mantissa of the result of 1(b). The results are now in the integer range interval [−2⁶², −2⁶²] (e.g., stored in 64-bit integer registers in memory). In the primary example, the casted values are:

$$0001000010110110000010110110000010110110000010110110000100000000$$

$$( X ⋆ {2}^{∧} 62 cast as signed integer )$$

$$0011001100110011001100110011001100110011001100110011010000000000$$

$$( Y ⋆ {2}^{∧} 62 cast as signed integer )$$

where the first bit is the sign bit.

In one embodiment, with the exception of the number 0, the mantissa (e.g., 52 bits) in the floating point number is assumed to have a 53^{rd} bit which is the most significant bit (MSB) of 1. Therefore, the casted value for each input includes a 1 at the 63^{rd} position corresponding to this implicit mantissa bit.

The next step (step “1(d)”) is to add 2⁶² to the result of 1(c). This is performed as an integer operation on 64-bit integers and therefore is exact. This maps values from the [−2⁶², 2⁶²] integer range to the [0, 2⁶³] integer range. In the primary example, the added values are:

$$0100000000000000000000000000000000000000000000000000000000000000$$

$$( {2}^{∧} 62 )$$

$$0101000010110110000010110110000010110110000010110110000100000000$$

$$( X ⋆ {2}^{∧} 62 cast as signed integer + {2}^{∧} 62 )$$

$$0111001100110011001100110011001100110011001100110011010000000000$$

$$( Y ⋆ {2}^{∧} 62 cast as signed integer + {2}^{∧} 62 ) .$$

The next step (step “1(e)”) is to take the 62 least significant bits (LSB's) of the result of 1(d) and create a geohash string. In the primary example, the generated words for each inputs are:

$$1010000101101100000101101100000101101100000101101100001000000000$$

$$( 62 LSB ’ s taken to create word for x )$$

$$1110011001100110011001100110011001100110011001100110100000000000$$

$$( 62 LSB ’ s taken to create word for y )$$

where the last 12 bits may not be used and may not affect the outcome.

In one embodiment, since the 62 LSB's of the number 0 and 2⁶³ are the same, they are distinguished by mapping 2⁶³ to 2⁶³−1. In the coordinate space, this mapping is conceptually equal to perturbing input values equal to 180 degrees for longitudes and 90 degrees for latitudes to slightly smaller values. Therefore, this mapping does not affect the latitude of the geohash result for precisions up to 18. For longitude it assigns 180 to the positive side of the antimeridian, and thus distinguishes it from −180 which is assigned to the negative side of the antimeridian. In practice, the mapping from 2⁶³ to 2⁶³−1 is done by taking the minimum of the result of step 1(d) and the constant 2⁶³−1.

The next step (step “2”) is to take resulting strings for each input value from step 1(e) and interleave the bits together to create interleaved geohashes encoding the latitude and longitude coordinates. In one embodiment, depending on the desired resolution of the geohash and the word size (e.g., 64 bits), there are multiple geohash representations generated for each input value. In one embodiment, a first interleaved geohash representation is created for each of the inputs that captures the geohash bits of a first set of resolutions. In one instance, the first interleaved geohash representation is generated by considering the 30 MSB's of the two 64-bit integers. If more bits are required by the desired geohash precision, the remaining bits of each integer are considered to generate a second interleaved geohash representation.

In the primary example, the desired geohash precision is 16, which corresponds to 16×5=80 interleaved bits (i.e., 40 bits from word for x and 40 bits from word for y). A set of first bitstrings to interleave is given by the first 30 bits from each string:

$$101000010110110000010110110000 ( first string to interleave x )$$

$$111001100110011001100110011001 ( first string to interleave y ) .$$

In one instance, the first interleaved geohash is generated by interleaving the bits from each string alternatively and padding the remaining LSB's of the 64-bit word. For example, the first interleaved geohash is given by:

$$1101110000010110001111001011010000010110001111001011010000010000$$

$$( first interleaved geohash ) .$$

Therefore, the first geohash is computed for precisions up to 12.

Since the desired precision is 16, a set of second bitstrings to interleave is given by the remaining 10 bits from each string:

$$0101101100 ( second string to interleave x )$$

$$1001100110 ( second string to interleave y ) .$$

The second interleaved geohash is generated by interleaving the bits from each string alternatively and padding the remaining LSB's of the 64-bit word. For example, the second interleaved geohash is given by:

$$0110001111001011010000000000000000000000000000000000000000000000$$

$$( second interleaved geohash )$$

where the last 44 bits may not be used and may not affect the outcome.
Therefore, the second geohash is computed for precisions from 13 to 16. In other examples, it is appreciated that a lower or higher precision geohash can be generated by removing or appending additional bits from the strings.

The next step (step “3”) is to convert the geohash strings computed in step 2 to a geohash encoding. The conversion is done by taking 5 bits at a time and mapping each set of 5 bits to one character out of 32 characters. In one embodiment, the mapping for the set of 32 characters is given by:
00000: ‘0,’ 00001: ‘1,’ 00010: ‘2,’ 00011: ‘3,’ 00100: ‘4,’ 00101: ‘5,’ 00110: ‘6,’ 00111: ‘7,’ 01000: ‘8,’ 01001: ‘9,’ 01010: ‘b,’ 01011: ‘c,’ 01100: ‘d,’ 01101: ‘e,’ 01110: ‘f,’ 01111: ‘g,’ 10000: ‘h,’ 10001: ‘j,’ 10010: ‘k,’ 10011: ‘m,’ 10100: ‘n,’ 10101: ‘p,’ 10110: ‘q,’ 10111: ‘r,’ 11000: ‘s,’ 11001: ‘t,’ 11010: ‘u,’ 11011: ‘v,’ 11100: ‘w,’ 11101: ‘x,’ 11110: ‘y,’ 11111: ‘z.’

In the primary example, the first geohash encoding obtained from the first string is given by:
‘vhc3te0q7ku1.’
   The second geohash encoding obtained from the second string is given by:
‘dg5n.’

In this manner, for a pair of longitude and latitude coordinates for precision up to 12, there are 2 floating point divisions, 2 floating point multiplications, 2 integer additions, 2 integer comparisons, 2 integer shifts, and 1 interleave operation. For precisions between 13 and 18, there are two additional 64-bit unsigned integers to represent the geohash value, and in terms of arithmetic operations, there are additionally 2 integer shifts and 1 interleave operation.

### 2. Reverse Geohashing

A reverse geohashing process computes a pair of longitude and latitude coordinate values from a geohash representation. In one embodiment, components of the cluster computing system 402 of FIG. 4 (e.g., one or more executor nodes) are configured to perform the steps described herein. In one embodiment, the geohash module 305 stores code that performs fast reverse geohashing. For the sake of explanation, a primary example where a geohash representation ‘vhc3te0q7ku1dg5n’ (that ideally encodes coordinates x=47 and y=72) is described herein. However, it is appreciated that any other appropriate values can be used in conjunction with the disclosure provided herein.

One step (step “1”) of reverse geohashing is to convert the input geohash string value to one or two 64-bit unsigned integers. In one embodiment, each character is converted to 5 bits, the outputs of which are represented as one or two 64-bit words (or any other word of appropriate bit length) depending on the precision of the geohash string. In one embodiment, the precisions supported are up to 20, for a total number of 100 bits. For precisions up to 12, the computing resource extracts 60 bits from the geohash representation that can fit in to a single 64-bit integer word. For precisions 13 to 20, the computing resource extracts between 75 to 100 bits. In such an embodiment, the first 60 bits are assigned to a first geohash string (e.g., 64-bit word), and the remaining 15 to 40 bits are assigned to a second geohash string (e.g., 64-bit word). In each of these cases, the extracted bits are the MSB's of the corresponding integer words, and the remaining bits in the word (e.g., trailing 4 bits for first string and between 24 to 49 bits for the second string) are set to 0.

In the primary example, the first geohash string is generated by extracting 60 bits from the geohash representation and is given by (e.g., stored in 64-bit integer registers in memory):

$$1101110000010110001111001011010000010110001111001011010000010000$$

$$( first extracted geohash string )$$

where the last 4 bits may not be used and may not affect the outcome.
Since the desired precision is 16, the second geohash string is generated by extracting remaining 20 bits from the geohash representation and is given by:

$$0110001111001011010000000000000000000000000000000000000000000000$$

$$( second extracted geohash string )$$

where the last 44 bits may not be used and may not affect the outcome.

The next step (step “2”) is to de-interleave the one or more integers computed in step 1. In one embodiment, when there is a single 64-bit integer, the compute resources extract two 32-bit integers, each corresponding to latitude or longitude, and including up to 30 bits of the input geohash. In one embodiment, when there are two 64-bit integers, the compute resources extract a first set of two 32-bit integers for the high part of the geohash, each including 30 bits from the input geohash value, and a second set of two 32-bit integers for the low part of the geohash, each including the remaining bits (i.e., between 8 and 20 bits for the first 32-bit integer, and between 7 and 20 for the second 32-bit integer).

Thus, the 2 or 4 32-bit integer values correspond to the mantissas of the longitude and latitude coordinates of the lower left corner of the geohash grid bucket of interest. Moreover, since the geohash bits occupy the MSB's of the 64-bit integer words computed in step 1, the 2 or 4 32-bit integer words computed in this step occupy the MSB's of these integers. In the primary example, a first set of integers are generated by de-interleaving bits alternatively from the first geohash string, each containing 30 MSB's for each of latitude and longitude:

$$10100001011011000001011011000000 ( first word for x )$$

$$11100110011001100110011001100100 ( first word for y )$$

where the last 2 bits of each word may not be used and may not affect the outcome.
Similarly, a second set of integers are generated by de-interleaving bits alternatively from the second geohash string (since the precision is 16 and is above 12), each containing 10 MSB's for each of latitude and longitude:

$$01011011000000000000000000000000 ( second word for x )$$

$$10011001100000000000000000000000 ( second word for y )$$

where the last 22 bits for each word may not be used and may not affect the outcome.

The next step (step “3”) is to produce one word for the latitude and another word for the longitude from the first and second sets of word generated in step 2. In one embodiment, when step 2 has generated two words (e.g., 2 32-bit integers), the method casts the integers to two 64-bit integers and scales the integers by 2³⁰, so that the values are in the integer range [0, 2⁶²]. In one instance, the scaling is performed by shifting the integers to the left by 30 bit positions. In another embodiment, when step 2 has generated two pairs of 32-bit integers (i.e., 4 32-bit integers), the method casts each integer to 64-bit integers and scales the high part of the integers by 2³⁰. The low part of the integers is not scaled. Subsequently, the scaled high part and the low part of each pair are concatenated to construct a 64-bit integer for each latitude and longitude in the integer range [0, 2⁶²).

In the primary example, the scaled high part of the integers is given by:

$$0010100001011011000001011011000000000000000000000000000000000000$$

$$( scaled first word for x cast to 64 - bit )$$

$$0011100110011001100110011001100100000000000000000000000000000000$$

$$( scaled first word for y cast to 64 - bit )$$

where the last 32 bits and the first 2 bits for each word may not be used and may not affect the outcome.
Similarly, the low part of the integers cast to 64-bit words is given by:

$$0000000000000000000000000000000001011011000000000000000000000000$$

$$( second word for x cast to 64 - bit )$$

$$0000000000000000000000000000000010011001100000000000000000000000$$

$$( second word for y cast to 64 - bit )$$

where the last 22 bits and the first 32 bits of each word may not be used and may not affect the outcome.
The concatenated words are given by:

$$0010100001011011000001011011000001011011000000000000000000000000$$

$$( concatenated word for x )$$

$$0011100110011001100110011001100110011001100000000000000000000000$$

$$( concatenated word for y )$$

where the last 22 bits and the first 2 bits of each word may not be used and may not affect the outcome.

In one embodiment, the method categories precisions into four categories, “very low” for precision 1, “low” for precisions 2 and 3, “medium” for precisions 4 to 6, “high” for precisions 7 to 12, and “very high” for precisions 13 to 20. Moreover, for different precision categories, the input geohash value is deinterleaved using integers of different bit lengths or sizes. In one instance, for the “very low” category, the deinterleaving is performed with 8-bit integers since 5 bits are less than 8 bits, for the “low” category, the deinterleaving is performed with 16-bit integers since 15 bits are less than 16 bits, for the “medium” category, the deinterleaving is performed with 32-bit integers since 30 bits is less than 32 bits, for the “high” category, the deinterleaving is performed with 64-bit integers since 60 bits is less than 64 bits, and for the “very high” category, the deinterleaving step is performed in two steps using 64-bit integers for each step.

The advantage of using different integer types for the deinterleaving process allows implementation in a more efficient manner the lower bit size the integer is. For example, comparing implementations of deinterleaving using 64-bit and 8-bit integers, the 64-bit version of deinterleave includes 6 bit-and operations, 5 bit-or operations, 5 shift operations, 6 assignment operations. In contrast, the number of operations for the 8-bit version are 3 bit-and operations, 2 bit-or operations, 2 shift operations, and 3 assignment operations, which is less than half the number of operations for the 64-bit version.

The next step (step “4”) is to cast the two 64-bit unsigned integers (or integers of any appropriate bit length) computed in step 3 to 64-bit signed integers. Moreover, the 64-bit integer values corresponding to the upper right corner of the geohash grid bucket is also computed. In one embodiment, the method adds 1 to the two signed integer values from step 3 at the appropriate bit position, which is the bit position corresponding to the LSB assigned to the integers in step 3 based on the input geohash value. Thus, after step 4, there are 4 64-bit signed integers in the range [0, 2⁶²] for the primary example.

The next step (step “5”) is to subtract the value of 2⁶¹ from the values from step 4 to map the words from the integer range [0, 2⁶²] to the integer range [−2⁶¹, 2⁶¹]. In the primary example, for the left side of the lower left corner:

$$0010100001011011000001011011000001011011000000000000000000000000$$

$$( concatenated string for x )$$

$$0010000000000000000000000000000000000000000000000000000000000000$$

$$( subtract {2}^{⋀} 61 )$$

$$0000100001011011000001011011000001011011000000000000000000000000$$

$$( concatenated string for x - {2}^{61} )$$

Similarly, for the low side of the lower left corner:

$$0011100110011001100110011001100110011001100000000000000000000000$$

$$( concatenated string for y )$$

$$0010000000000000000000000000000000000000000000000000000000000000$$

$$( subtract {2}^{⋀} 61 )$$

$$0001100110011001100110011001100110011001100000000000000000000000$$

$$( concatenated string for y - {2}^{61} ) .$$

The next step (step “6”) is to cast the 64-bit signed integers to double values (e.g., stored in 64-bit floating point registers in memory). In the primary example:

$$0100001110100000101101100000101101100000101101100000101101100001$$

$$( cast to double for x )$$

$$0100001110111001100110011001100110011001100110011001100110011010$$

$$( cast to double for y )$$

where the first bit is the sign bit.
A similar process can be performed for the upper right corner of the geohash bucket. Subsequently, the casted values are divided by 2⁶¹, and then multiplied with a respective factor f, where f is 180 for the integers corresponding to longitude values, and 90 for the integers corresponding to latitude values. The casting to double values maintains the 53 MSB's of the integers, and these bits become the bits of the mantissa of the double values. The floating point division by 2⁶¹ changes the mantissa of the doubles, and maps the 4 integers from step 5 from the [−2⁶¹, 2⁶¹] integer range to the [−1, 1] interval. The floating point multiplication maps the [−1, 1] interval to [−180, 180] for longitudes, and to [−90, 90] for latitudes. The four double values we computed at this step are the longitude and latitude minimum and maximum values of the geohash grid bucket.

In this manner, for a pair of longitude and latitude coordinates for left bottom corner and upper right corner of the geohash bucket for precision up to 12, there are 1 deinterleave operation, 6 integer shifts, 1 integer multiplication, 3 integer additions, 6 integer subtractions, 4 floating point divisions, 4 floating point multiplications. For precisions between 13 and 18, there is 1 additional deinterleave operation and 2 integer bit-or operations.

### 3. Fast Axis-Aligned Box Geohashing

In one embodiment, one request from a user of the data processing service 102 is given a non-empty geometry representing a geography region with coordinates in degrees (assuming the geometry does not cross the antemeridian), return the geohash grid bucket of the largest precision that includes the axis-aligned bounding of the geometry. In one instance, one way to solve this technical problem is to identify the four corners of the axis-aligned bounding box of the geometry, compute the geohash strings for the four corners of the box, and then identify the common prefix of the four geohash strings. However, this involves iteratively comparing each character of the geohash strings until a character is found that differs at a given precision.

Thus, in one embodiment, a geohash grid bucket computing process computes a geohash box including the bounding box of the geography using the fast geohash process described above. In particular, the process takes advantage of using a common prefix in the bit representation of the geohashes, rather than performing the comparison using geohash characters themselves. In one embodiment, components of the cluster computing system 402 of FIG. 4 (e.g., one or more executor nodes) are configured to perform the steps described herein. In one embodiment, the geohash module 305 stores code that performs the geohash grid bucket computing process.

One step (step “1”) is to obtain the input axis-aligned bounding box covering the geometry. In one instance, the process herein takes advantage of the fact that only the coordinates of the lower left corner and the upper right corner of the bounding box can be used to identify the geohash bucket that contains the geometry. In step 1, the coordinates of the lower left and the upper right corner of the bounding box are transformed to 64-bit integers in the [0, 2⁶³) integer range. In one embodiment, the process described with respect to steps 1(a)-1(e) in the Section 1 titled “Forward Geohashing” is applied to each coordinate to perform the transformation.

A next step (step “2”) is to scale the integers from step 1 to the [0, 2³²) integer range. In one embodiment, the scaling is performed by performing a right shift operation (the shift value is 31). The scaling is performed when a maximum precision of up to 12 is desired, which means only 60 maximum bits are needed for the geohash of each of the two corners of the bounding box. Therefore, only 30 maximum bits per longitude and latitude value are needed. By performing the scaling, the 32 MSB's of the integer representation of the longitude and latitude values of the corners of the bounding box are retained.

A next step (step “3”) is for each corner coordinate, the 32-bit integers from step 2 for each of longitude and the latitude are interleaved, similar to the process in step 2 of Section 1 titled “Forward Geohashing.” The interleaving generates two 64-bit unsigned integers that each are the geohash representation of the two corners of the bounding box at precision 12 (that is, first 60 bits of each integer when each precision corresponds to 5 bits).

A next step (step “4”) is to perform a bit-xor operation of the two 64-bit integers from step 3. The process applies a count operation (“std::count1_zero” in C++20) to count the number of leading consecutive zero bits in each of the integers. The process then integer divides the result of the count operation by 5 to compute the maximum precision or number of leading geohash characters that are common to the geohash strings of the lower left and upper right corners of the bounding box.

A next step (step “5”) is to take any of the two unsigned integer representations computed in step 3 and encode as a geohash string of length equal to the result of step 4. For example, if the maximum precision in step 4 was found to be 8, step 5 returns the 8 common geohash characters to the user as the geohash bucket for the geometry.

In the process described herein, instead of computing the geohash strings for the lower left and upper right corner of the bounding box, an integer representation of the geohash is computed at Step 3, where the integer representation encodes two or more precisions (e.g., 12 precisions). The integer representations of the two corner coordinates are compared via the bit-xor operation, rather than generating a full geohash character representation.

Thus, one technical advantage over existing methods is the integer representations of the corner coordinates are compared rather than the geohash characters themselves. This is possible because the forward geohashing process described in Section 1 generates an integer representation for the geohash representation. Moreover, a lesser number of bytes are compared to obtain the common prefix for the geohash bucket. As an example, with a precision up to 12, 12 bytes are compared between two geohash strings, while in the integer space, only 8 bytes are compared. A second technical advantage is by using the fast forward geohashing process to obtain the integer representations, a lesser number of operations are performed compared to other methods. A third technical advantage is that only two corners, rather than all four corners, are used to find the common prefix, therefore, a smaller number of comparisons can be performed, overall resulting in improvements in computational efficiency and memory.

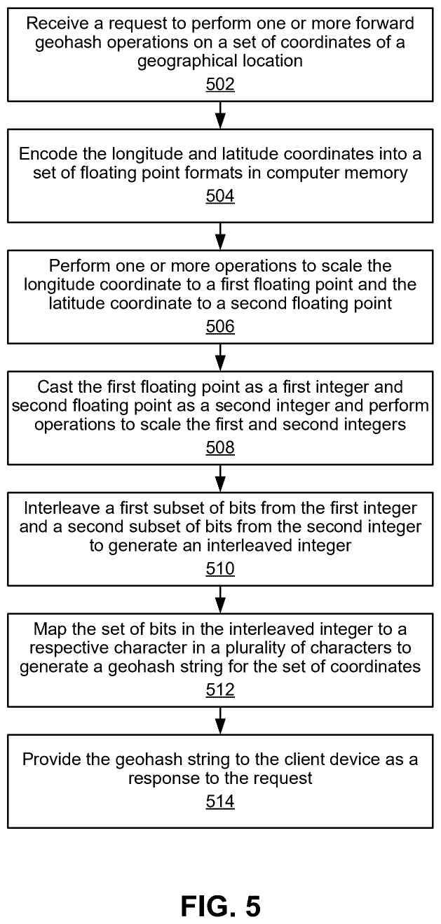

FIG. 5 illustrates a method for performing a geohash operation to a set of coordinates, in accordance with an embodiment. The process shown in FIG. 5 may be performed by one or more components (e.g., the control layer 106 or the data layer 108) of a data processing system/service (e.g., the data processing service 102). Other entities may perform some or all of the steps in FIG. 5. Embodiments may include different and/or additional steps, or perform the steps in different orders.

The data processing service 102 receives 502, from a client device, a request to perform one or more forward geohash operations on a set of coordinates of a geographical location, the set of coordinates including at least a longitude coordinate and a latitude coordinate, and the request including a desired precision. The data processing service 102 encodes 504 the longitude coordinate and the latitude coordinate into a set of floating point formats in computer memory. The data processing service 102 performs 506 one or more operations to scale the longitude coordinate to a first floating point in a first range and scale the latitude coordinate to a second floating point in a second range. The data processing service 102 casts 508 the first floating point as a first integer and the second floating point as a second integer and performing another one or more operations to scale the first integer to a third range and scale the second integer to a fourth range. Depending on the desired precision, the data processing service 102 interleaves 510 a first subset of bits from the first integer and a second subset of bits from the second integer together to generate at least an interleaved integer. For each of one or more sets of bits in the interleaved integer, the data processing service 102 maps 512 the set of bits to a respective character in a plurality of characters to generate a geohash string for the set of coordinates. The data processing service 102 provides 514 the geohash string to the client device as a response to the request.

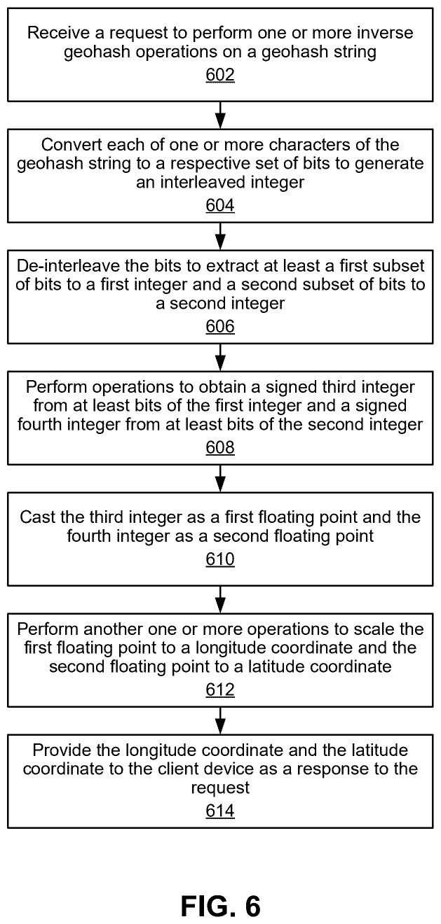

FIG. 6 illustrates a method for performing a reverse geohash operation to a geohash string, in accordance with an embodiment. The process shown in FIG. 6 may be performed by one or more components (e.g., the control layer 106 or the data layer 108) of a data processing system/service (e.g., the data processing service 102). Other entities may perform some or all of the steps in FIG. 6. Embodiments may include different and/or additional steps, or perform the steps in different orders.

The data processing service 102 receives 602, from a client device, a request to perform one or more inverse geohash operations on a geohash string. A number of characters in the geohash string is indicative of precision. Depending on the precision of the geohash string, the data processing service 102 converts 604 each of one or more characters of the geohash string to a respective set of bits to generate at least an interleaved integer in computer memory. The data processing service 102 de-interleaves 606 the bits in the interleaved integer to extract at least a first subset of bits to a first integer and a second subset of bits to a second integer. The data processing service 102 performs 608 one or more operations to obtain a signed third integer from at least bits of the first integer and a signed fourth integer from at least bits of the second integer. The data processing service 102 then casts 610 the third integer as a first floating point and casting the fourth integer as a second floating point. The data processing service 102 performs 612 one or more operations to scale the first floating point to a longitude coordinate and the second floating point to a latitude coordinate. The data processing service 102 provides 614 the longitude coordinate and the latitude coordinate to the client device as a response to the request.

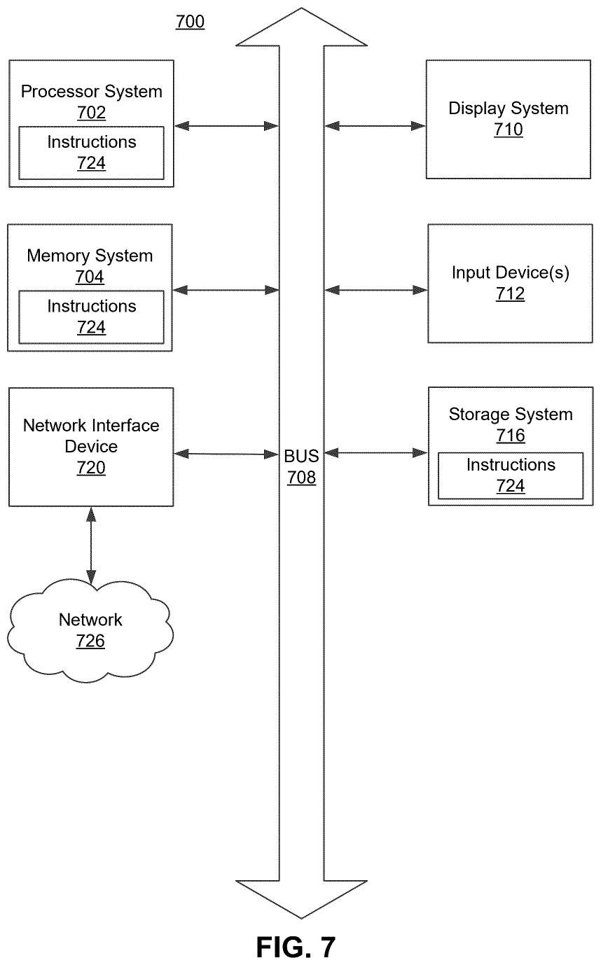

Turning now to FIG. 7, illustrated is an example machine to read and execute computer readable instructions, in accordance with an embodiment. Specifically, FIG. 7 shows a diagrammatic representation of the data processing service 102 (and/or data processing system) in the example form of a computer system 700. The computer system 700 is structured and configured to operate through one or more other systems (or subsystems) as described herein. The computer system 700 can be used to execute instructions 724 (e.g., program code or software) for causing the machine (or some or all of the components thereof) to perform any one or more of the methodologies (or processes) described herein. In executing the instructions, the computer system 700 operates in a specific manner as per the functionality described. The computer system 700 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 700 may be a server computer, a client computer, a personal computer (PC), a tablet PC, a smartphone, an internet of things (IoT) appliance, a network router, switch or bridge, or other machine capable of executing instructions 724 (sequential or otherwise) that enable actions as set forth by the instructions 724. Further, while only a single machine is illustrated, the term “machine” shall also be taken to include any collection of machines that individually or jointly execute instructions 724 to perform any one or more of the methodologies discussed herein.

The example computer system 700 includes a processing system 702. The processor system 702 includes one or more processors. The processor system 702 may include, for example, a central processing unit (CPU), a graphics processing unit (GPU), a neural network processor (NPU), a digital signal processor (DSP), a controller, a state machine, one or more application specific integrated circuits (ASICs), one or more radio-frequency integrated circuits (RFICs), or any combination of these. The processor system 702 executes an operating system for the computing system 700. The computer system 700 also includes a memory system 704. The memory system 704 may include or more memories (e.g., dynamic random access memory (RAM), static RAM, cache memory). The computer system 700 may include a storage system 716 that includes one or more machine readable storage devices (e.g., magnetic disk drive, optical disk drive, solid state memory disk drive).

The storage unit 716 stores instructions 724 (e.g., software) embodying any one or more of the methodologies or functions described herein. For example, the instructions 724 may include instructions for implementing the functionalities of the data processing service 102 as described herein. The instructions 724 may also reside, completely or at least partially, within the memory system 704 or within the processing system 702 (e.g., within a processor cache memory) during execution thereof by the computer system 700, the main memory 704 and the processor system 702 also constituting machine-readable media. The instructions 724 may be transmitted or received over a network 726, such as the network 726, via the network interface device 720.

The storage system 716 should be taken to include a single medium or multiple media (e.g., a centralized or distributed database, or associated caches and servers communicatively coupled through the network interface system 720) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and/or magnetic media.

In addition, the computer system 700 can include a display system 710. The display system 710 may driver firmware (or code) to enable rendering on one or more visual devices, e.g., drive a plasma display panel (PDP), a liquid crystal display (LCD), or a projector. The computer system 700 also may include one or more input/output systems 712. The input/output (IO) systems 712 may include input devices (e.g., a keyboard, mouse (or trackpad), a pen (or stylus), microphone) or output devices (e.g., a speaker). The computer system 700 also may include a network interface system 720. The network interface system X20 may include one or more network devices that are configured to communicate with an external network 726. The external network 726 may be a wired (e.g., ethernet) or wireless (e.g., WiFi, BLUETOOTH, near field communication (NFC).

The processor system 702, the memory system 704, the storage system 716, the display system 710, the IO systems 712, and the network interface system 720 are communicatively coupled via a computing bus 708.

### ADDITIONAL CONSIDERATIONS

The foregoing description of the embodiments of the disclosed subject matter have been presented for the purpose of illustration; it is not intended to be exhaustive or to limit the disclosed embodiments to the precise forms disclosed. Moreover, persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A computer-implemented method, comprising:
receiving, from a client device, a request to perform one or more forward geohash operations on a set of coordinates of a geographical location, the set of coordinates including at least a longitude coordinate and a latitude coordinate, and the request including a desired precision;
encoding the longitude coordinate and the latitude coordinate into a set of floating point formats in computer memory;
performing one or more operations to scale the longitude coordinate to a first floating point in a first range and scale the latitude coordinate to a second floating point in a second range;
casting the first floating point as a first integer and the second floating point as a second integer and performing another one or more operations to scale the first integer to a third range and scale the second integer to a fourth range;
depending on the desired precision, interleaving a first subset of bits from the scaled first integer and a second subset of bits from the scaled second integer together to generate at least an interleaved integer;
for each of one or more sets of bits in the interleaved integer, mapping the set of bits to a respective character in a plurality of characters to generate a geohash string for the set of coordinates; and
providing the geohash string to the client device as a response to the request.

2. The method of claim 1, wherein each of the one or more sets of bits in the interleaved integer is a respective set of 5 bits, and wherein the plurality of characters is a set of 32 characters.

3. The method of claim 1, wherein the desired precision is 12 or less, and wherein a number of the first subset of bits combined with a number of the second subset of bits is 5 times the desired precision.

4. The method of claim 1, wherein the desired precision is 13 or more, wherein the first subset of bits from the first integer are 30 bits from the first integer and the second subset of bits are 30 bits from the second integer, and the method further comprises:
interleaving a third subset of bits subsequent the first subset of bits from the first integer and a fourth subset of bits subsequent the second subset of bits from the second integer together to generate a second interleaved integer.

5. The method of claim 1, wherein the set of floating point formats each occupy a 64-bit word in the computer memory, wherein each of the first range and the second range is [−2⁶², −2⁶²], and wherein each of the third range and the fourth range is [0, 2⁶³].

6. The method of claim 1, wherein the desired precision is 12 or less, wherein the operations comprise at most 2 floating point divisions, 2 floating point multiplications, 2 integer additions, 2 integer comparisons, and 2 integer shifts.

7. The method of claim 1, wherein the desired precision is 13 or more, wherein the operations comprise at most 2 floating point divisions, 2 floating point multiplications, 2 integer additions, 2 integer comparisons, 4 integer shifts.

8. A non-transitory computer-readable storage medium storing instructions that, when executed by a processor, cause the processor to:
receive, from a client device, a request to perform one or more forward geohash operations on a set of coordinates of a geographical location, the set of coordinates including at least a longitude coordinate and a latitude coordinate, and the request including a desired precision;
encode the longitude coordinate and the latitude coordinate into a set of floating point formats in computer memory;
perform one or more operations to scale the longitude coordinate to a first floating point in a first range and scale the latitude coordinate to a second floating point in a second range;
cast the first floating point as a first integer and the second floating point as a second integer and performing another one or more operations to scale the first integer to a third range and scale the second integer to a fourth range;
depending on the desired precision, interleave a first subset of bits from the scaled first integer and a second subset of bits from the scaled second integer together to generate at least an interleaved integer;
for each of one or more sets of bits in the interleaved integer, map the set of bits to a respective character in a plurality of characters to generate a geohash string for the set of coordinates; and
provide the geohash string to the client device as a response to the request.

9. The non-transitory computer-readable storage medium of claim 8, wherein each of the one or more sets of bits in the interleaved integer is a respective set of 5 bits, and wherein the plurality of characters is a set of 32 characters.

10. The non-transitory computer-readable storage medium of claim 8, wherein the desired precision is 12 or less, and wherein a number of the first subset of bits combined with a number of the second subset of bits is 5 times the desired precision.

11. The non-transitory computer-readable storage medium of claim 8, wherein the desired precision is 13 or more, wherein the first subset of bits from the first integer are 30 bits from the first integer and the second subset of bits are 30 bits from the second integer, and the instructions further cause the processor to:
Interleave a third subset of bits subsequent the first subset of bits from the first integer and a fourth subset of bits subsequent the second subset of bits from the second integer together to generate a second interleaved integer.

12. The non-transitory computer-readable storage medium of claim 8, wherein the set of floating point formats each occupy a 64-bit word in the computer memory, wherein each of the first range and the second range is [−2⁶², −2⁶²], and wherein each of the third range and the fourth range is [0, 2⁶³].

13. The non-transitory computer-readable medium of claim 8, wherein the desired precision is 12 or less, wherein the operations comprise at most 2 floating point divisions, 2 floating point multiplications, 2 integer additions, 2 integer comparisons, and 2 integer shifts.

14. The non-transitory computer-readable storage medium of claim 8, wherein the desired precision is 13 or more, wherein the operations comprise at most 2 floating point divisions, 2 floating point multiplications, 2 integer additions, 2 integer comparisons, 4 integer shifts.

15. A computer system comprising:
a processor; and
a non-transitory computer-readable storage medium storing instructions that, when executed by a processor, cause the processor to:
receive, from a client device, a request to perform one or more forward geohash operations on a set of coordinates of a geographical location, the set of coordinates including at least a longitude coordinate and a latitude coordinate, and the request including a desired precision;
encode the longitude coordinate and the latitude coordinate into a set of floating point formats in computer memory;
perform one or more operations to scale the longitude coordinate to a first floating point in a first range and scale the latitude coordinate to a second floating point in a second range;
cast the first floating point as a first integer and the second floating point as a second integer and performing another one or more operations to scale the first integer to a third range and scale the second integer to a fourth range;
depending on the desired precision, interleave a first subset of bits from the scaled first integer and a second subset of bits from the scaled second integer together to generate at least an interleaved integer;
for each of one or more sets of bits in the interleaved integer, map the set of bits to a respective character in a plurality of characters to generate a geohash string for the set of coordinates; and
provide the geohash string to the client device as a response to the request.

16. The computer system of claim 15, wherein each of the one or more sets of bits in the interleaved integer is a respective set of 5 bits, and wherein the plurality of characters is a set of 32 characters.

17. The computer system of claim 15, wherein the desired precision is 12 or less, and wherein a number of the first subset of bits combined with a number of the second subset of bits is 5 times the desired precision.

18. The computer system of claim 15, wherein the desired precision is 13 or more, wherein the first subset of bits from the first integer are 30 bits from the first integer and the second subset of bits are 30 bits from the second integer, and the instructions further cause the processor to:
interleave a third subset of bits subsequent the first subset of bits from the first integer and a fourth subset of bits subsequent the second subset of bits from the second integer together to generate a second interleaved integer.

19. The computer system of claim 15, wherein the set of floating point formats each occupy a 64-bit word in the computer memory, wherein each of the first range and the second range is [−2⁶², −2⁶²], and wherein each of the third range and the fourth range is [0, 2⁶³].

20. The computer system of claim 15, wherein the desired precision is 12 or less, wherein the operations comprise at most 2 floating point divisions, 2 floating point multiplications, 2 integer additions, 2 integer comparisons, and 2 integer shifts.

21. The computer system of claim 15, wherein the desired precision is 13 or more, wherein the operations comprise at most 2 floating point divisions, 2 floating point multiplications, 2 integer additions, 2 integer comparisons, 4 integer shifts.
